(19) United States
(12) Patent Application Publication
(10) Pub. No.: US 2005/0259280 A1
(43) Pub. Date: Nov. 24, 2005

(54) Color management of halftone prints

(75) Inventor: William A. Rozzi, Stillwater, MN (US)

Correspondence Address: BETH READ;PATENT LEGAL STAFF, EASTMAN KODAK COMPANY, 343 STATE STREET, ROCHESTER, NY, 14650-2201, US

(73) Assignee: Kodak Polychrome Graphics, LLC, Norwalk, CT (US)

(21) Appl. No.: 11/121,707

(22) Filed: May 4, 2005

Related U.S. Application Data
(60) Provisional application No. 60/568,289, filed on May 5, 2004.

(51) Int. Cl. H04N 1/52

(52) U.S. Cl. 358/1.9; 358/534; 358/3.23

(57) ABSTRACT

Techniques are described for color management of halftone prints by direct modification of halftone dot perimeters within bi-level, halftoned bitmap images. According to the halftone print color management techniques, border pixels of the halftone dots are spatially selected to be turned on or off in order to appropriately shrink or grow the halftone dots. The bitmap image may be prepared to create both a halftone proof and printing plates. Therefore, contrary to conventional continuous-tone color management techniques, direct halftone bitmap modification minimizes dot structure differences between data used to produce a proof and corresponding printing plates. The perimeter of a halftone dot within a bitmap image is modified by applying a local threshold value to a distance mapped bitmap image. The bitmap image may be bipolar distance mapped (BDM) to allow for shrinking or growing of the halftone dots by varying a threshold value.

This application claims the benefit of U.S. provisional application No. 60/568,289, filed May 5, 2004, the entire content of which is incorporated herein by reference.

### TECHNICAL FIELD

The invention relates to halftone print color management techniques, and more particularly color management of bitmap images.

### BACKGROUND

Halftone prints are produced from bi-level images that indicate the presence or absence of ink at a particular location within the image. Variation of halftone dot sizes controls tonal values within a clustered-dot halftone print. For example, smaller dots produce lighter shades and larger dots produce darker shades.

A halftone image file can be viewed as a bitmap. Each bit is used to indicate whether a pixel is on or off. Color halftone printing devices make use of different channels, e.g., Cyan (C), Magenta (M), Yellow (Y), and Black (K), to define colors. Thus, color halftone prints may include a plurality of monochromatic bitmaps. Each monochromatic bitmap defines the presence or absence of dots for a particular channel.

Color management may be applied to halftone prints by modification of continuous-tone image data prior to halftoning. Color management via modification of continuous-tone image data requires that pages be rendered twice, once for a proof and once for printing plates. However, rendering the pages twice can result in different dot structures on the proof and the plates.

### SUMMARY

In general, the invention is directed to techniques for color management of halftone prints by direct modification of halftone dot perimeters within a bi-level, halftoned bitmap image. According to the halftone print color management techniques, border pixels of the halftone dots are spatially selected to be turned on or off in order to appropriately shrink or grow the halftone dots. The bitmap image may be prepared to create both a halftone proof and printing plates. Therefore, in contrast to other continuous-tone color management techniques, the direct halftone bitmap modification techniques described herein can minimize dot structure differences between data used to produce a proof and data used to produce corresponding printing plates.

The bitmap image may be bipolar distance mapped (BDM) to allow for shrinking or growing of the halftone dots by varying a threshold value. Bipolar distance mapping the bitmap image encodes each pixel in the bitmap image with a distance from a closest boundary pixel and a radial sector location of the closest boundary pixel. In that way, each radial sector, e.g., an octant, of a halftone dot may be controlled separately to increase color accuracy between the halftone proof and the corresponding printing plates.

A local threshold value is applied to the BDM image to modify the bitmap image to a desired color level that accurately represents an output of the printing plates created from the original bitmap image. In one embodiment, each local threshold value is selected based on a current local continuous-tone value estimated from the bitmap image and a desired local continuous-tone value determined from a color mapping of the current local continuous-tone value. In another embodiment, each local threshold value is selected based only on a desired local continuous-tone value determined from a color mapping of a current local continuous-tone value. In either case, the color mapping may be a device link profile, such as an International Color Consortium (ICC) device link profile.

In one embodiment, the invention is directed to a method for adjusting color in a bitmap image. The method comprises locally modifying a perimeter of a halftone dot within the bitmap image by applying a local threshold value to a distance mapped bitmap image.

In another embodiment, the invention is directed to a computer-readable medium comprising instructions to cause a processor to perform a method for adjusting color in a bitmap image. The computer-readable medium comprises instructions for causing a programmable processor to locally modify a perimeter of a halftone dot within the bitmap image by applying a local threshold value to a distance mapped bitmap image.

In another embodiment, the invention is directed to a system comprising a processor that color adjusts an original bitmap image. The original bitmap image is color adjusted by locally modifying a perimeter of a halftone dot within the bitmap image by applying a local threshold value to a distance mapped bitmap image.

The invention may provide several advantages. For example, color management by direct modification of halftone dot perimeters reduces differences between data used to produce a proof and data used to form corresponding printing plates, and leads to increased user confidence in the geometric and colorimetric accuracy of the halftone proof. Furthermore, the invention provides a RIP-once workflow that prepares a halftone bitmap used for creating both a proof and printing plates. Direct bitmap modification may be applied for a variety of halftone proofing systems, including thermal halftone proofing systems such as the Kodak Polychrome Graphics (KPG) Matchprint Digital Halftone proofing system or the Kodak Approval proofing system.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary halftone color management system.

FIG. 2A is a diagram illustrating application of a threshold to a halftone bitmap using Euclidean distance mapping techniques.

FIG. 2B is a diagram illustrating application of a threshold to a halftone bitmap using bipolar distance mapping techniques.

FIG. 3 is a block diagram illustrating an exemplary dot growth filter.

FIG. 4 is a schematic diagram illustrating a bipolar distance mapped pixel word.

FIG. 5 is a block diagram illustrating a workflow raster image processor (RIP) generating an original bitmap.

FIG. 6 is a schematic diagram illustrating an example halftone proofer.

FIG. 7 is a flowchart illustrating a method of generating a threshold value lookup table.

FIG. 8 is a flowchart illustrating a method of computing a threshold value in greater detail.

FIG. 9A is a plot illustrating a threshold lookup table before post processing.

FIG. 9B is a plot illustrating a threshold lookup table after post processing.

FIG. 10 is a block diagram illustrating another exemplary halftone print color management system.

FIG. 11 is a block diagram illustrating another exemplary dot growth filter.

FIG. 12 is a plot illustrating a cumulative histogram.

FIG. 13 is a flowchart illustrating a method of color correcting a halftone bitmap image.

### DETAILED DESCRIPTION

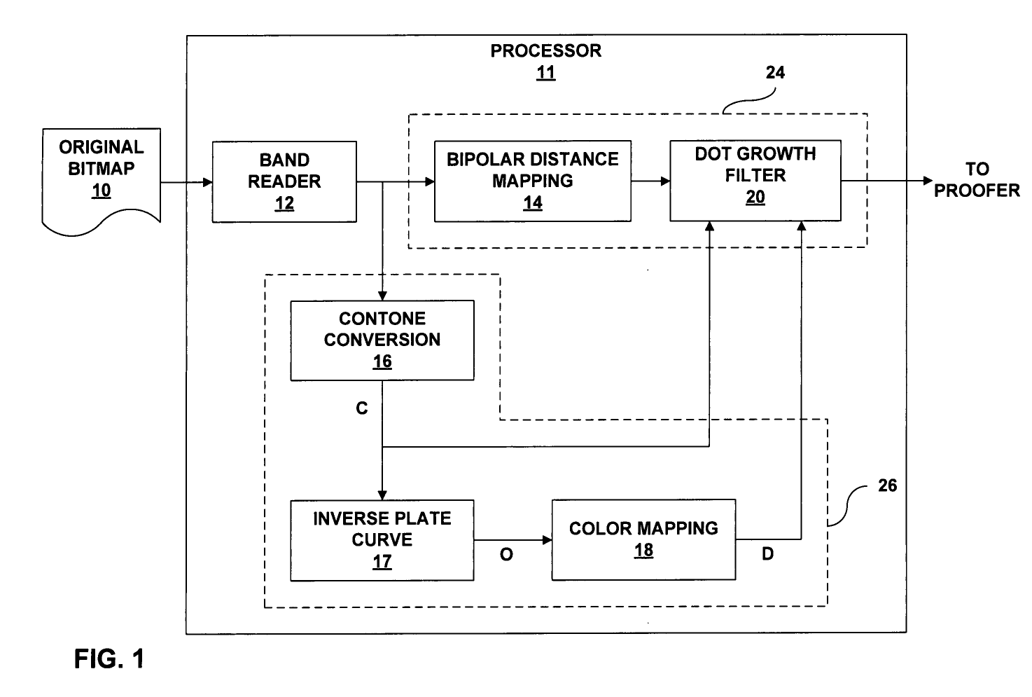

FIG. 1 is a block diagram illustrating an exemplary halftone print color management system. The system described herein directly modifies a halftone bitmap image in order to minimize differences between data used to produce a proof and data used to produce corresponding printing plates. Substantially eliminating differences between the data leads to increased user confidence in the geometric and colorimetric accuracy of the resulting halftone proof.

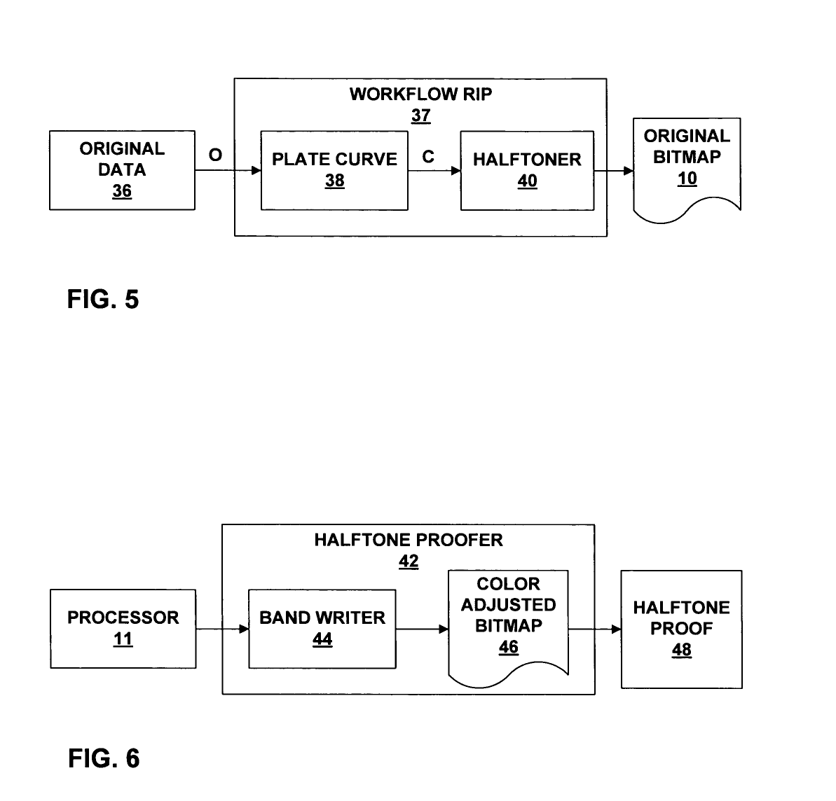

As illustrated in FIG. 1, an original bitmap image 10 is provided as input to a processor 11 included in the color management system. Original bitmap image 10 may be used to create printing plates in a platesetter, for example. Processor 11 prepares bitmap image 10 to create a halftone proof substantially similar to an output from the printing plates. A workflow raster image processor (RIP), as illustrated in FIG. 5, may generate original bitmap image 10. In other embodiments, original bitmap image 10 may be generated by another means.

Processor 11, as illustrated in FIG. 1, includes a band reader 12, a bi-level path 24, and a continuous-tone (contone) path 26. Due to the file sizes that are typical of plate-ready bitmaps, band reader 12 allows original bitmap image 10 to be read and processed in image bands. Each of the image bands comprises a plurality of halftone dots and/or inked areas that may be manipulated to produce an accurate color in a halftone proof relative to original bitmap image 10.

Bi-level path 24 comprises elements necessary to perform halftone dot perimeter modifications. Bi-level path 24 includes a bipolar distance mapping (BDM) module 14 and a dot growth filter 20. Contone path 26 determines the degree of modification necessary for the halftone dots within a local region of original bitmap 10 to obtain the desired color output. Contone path 26 includes a contone conversion module 16, an inverse plate curve module 17, and a color mapping module 18.

Euclidean distance mapping (EDM) is an image processing technique in which each pixel in a bi-level image is encoded with its distance to a nearest boundary pixel of a corresponding halftone dot. Applying a threshold operation to an EDM image produces a second bi-level image in which the size of foreground objects grow with increasing threshold value. If the notions of foreground and background are reversed, a bi-level image may be obtained in which the foreground objects shrink with increasing threshold.

Growth and reduction of an object by turning pixels of halftone dots on and off, respectively, results in an apparent change in color density. Turning on additional pixels to grow the object increases the apparent color density, whereas turning off pixels to reduce the size of the object reduces apparent color density. Accordingly, controlled activation of pixels in a halftone bitmap image can be used to visually approximate desired colors.

BDM module 14 receives the image bands of original bitmap 10 from band reader 12. BDM module 14 bipolar distance maps the image bands by performing two passes of a standard EDM algorithm, as described above. A first pass produces a conventional EDM image. A second pass produces an EDM image with the foreground and background labels reversed. The two resulting EDM images are combined into a single BDM image that allows for shrinking or growing of foreground objects by varying a threshold value.

In addition to recording the distance from a closest boundary pixel for each pixel in a corresponding halftone dot, the image encoding scheme of BDM module 14 also records a position of each pixel relative to one of an interior or exterior of the halftone dot and a radial sector location in which a given pixel's nearest boundary pixel resides. In that way, each radial sector, e.g., an octant, of a halftone dot may be controlled separately to increase color accuracy between the halftone proof and the corresponding printing plates.

The BDM encoding scheme allows partial modification of foreground object boundaries, unlike the EDM images which add or remove pixels all the way around the entire perimeter of foreground objects with each step of the threshold. In other words, increasing the threshold applied to an EDM image causes all boundary pixels to be replaced with foreground pixels.

In contrast, only a fraction of the boundary pixels within the BDM encoded image are replaced. The boundary pixels of the BDM image are spatially selected for addition or removal based on the data encoded in each pixel by BDM module 14. The fractional boundary modification capability of BDM images allows finer control of color adjustment, which is important for application to bitmap color management.

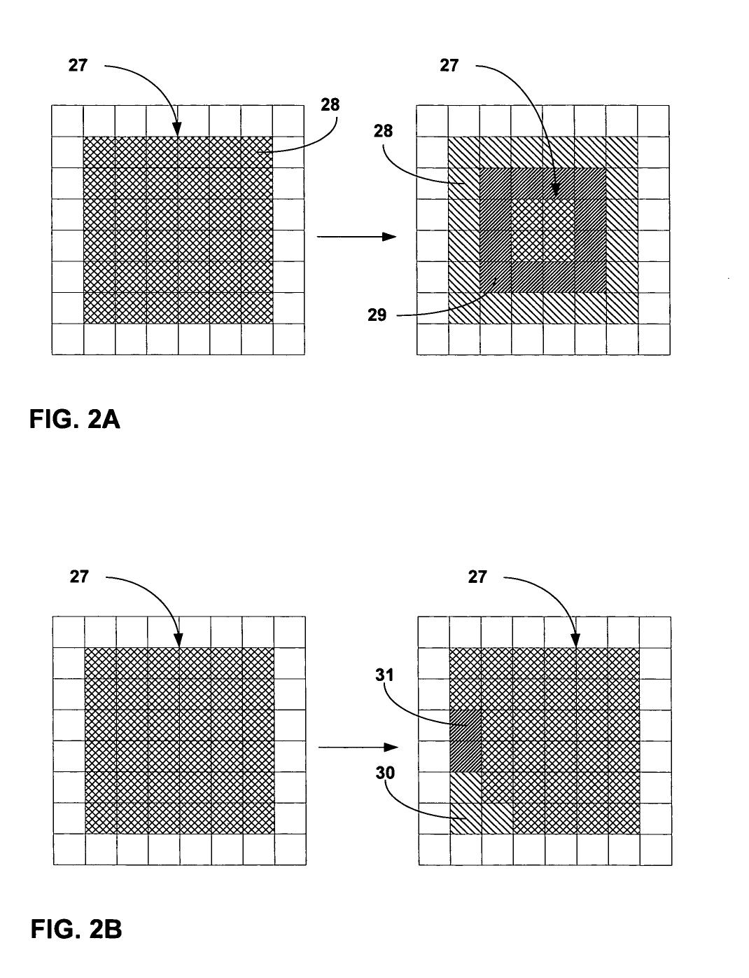

FIG. 2A is a diagram illustrating application of a threshold to a Euclidean distance mapped (EDM) halftone bitmap. As shown in FIG. 2A, the EDM bitmap image includes a foreground object 27 with a boundary 28. A threshold may be applied to the EDM halftone bitmap to selectively add or remove pixels situated at a given distance requirement to respectively grow or shrink original foreground object 27.

In the illustrated embodiment, a threshold value is applied to the EDM image in order to shrink foreground object 27. Applying the threshold value results in deactivation of all pixels at boundary 28 surrounding foreground object 27. As the threshold value is changed, additional pixels at subsequent distances can be turned off to further shrink foreground object 27. For example, a sufficient threshold decrease may turn off pixels at a boundary 29.

FIG. 2B is a diagram illustrating application of a threshold to a bipolar distance mapped (BDM) halftone bitmap in accordance with an embodiment of the invention. The BDM image includes a foreground object 27. In the illustrated embodiments, the BDM halftone bitmap includes eight radial sectors. In other embodiments, a BDM halftone bitmap may include more or fewer radial sectors. For example, a BDM halftone bitmap may include sixteen radial sectors.

As shown in FIG. 2B, a threshold is applied to the BDM halftone bitmap, which includes radial sector tracking, e.g., octant tracking, to selectively remove pixels that satisfy a distance requirement and are within a selected octant 30 to shrink an original foreground object 27. As the threshold value is changed, additional pixels in subsequent octants may be turned off to further shrink foreground object 27. For example, with a sufficient threshold decrease, pixels in an additional octant 31 are turned off. In this manner, the BDM technique with radial sector tracking provides a finer degree of control in response to changes in desired continuous tone color appearance.

In this illustration, the foreground object modification process may proceed by selectively turning off boundary pixels in a series of successive octants that extend in a clockwise direction about the perimeter of object 27. The octants may be spatially selected for removal in a spiral pattern about the perimeter of foreground object 27. In other embodiments, octants may be selected in a counter-clockwise direction about the perimeter of object 27. In further embodiments, octants may be selected for removal according to other patterns about object 27 or the octants may be selected randomly.

With further reference to FIG. 1, BDM module 14 sends the BDM-encoded image bands to dot growth filter 20. Dot growth filter 20 receives bands of contone values and determines threshold values to be applied to the corresponding pixels of the BDM image bands to obtain a modified bitmap image. The bands of contone values are supplied by contone path 26, described in further detail below. The threshold values manipulate halftone dots and/or inked areas within the BDM image bands to create a color accurate proof relative to original bitmap 10. The modified bitmap image output from dot growth filter 20 may be stored and used directly to make a halftone proof.

Contone path 26 begins with a contone conversion module 16, which converts the image bands of original bitmap 10 from a high-resolution, bi-level image to a lower-resolution, continuous-tone image. Contone conversion module 16 performs the conversion by applying a two-pass Gaussian blur and reduce operation. As an example, the first pass may directly convert bytes (8 packed pixels) in each image band to an intermediate row-wise blurred and reduced contone image. The second pass applies the blur and scale reduction to columns of the intermediate image output by the first pass to produce the converted image. The contone-converted image is then applied to inverse plate curve module 17 and dot growth filter 20, as will be described.

Each pixel of the contone-converted image represents an estimate of the continuous-tone value at a corresponding location within an original continuous-tone image. The original data may include an applied one-dimensional (1-D) plate curve, i.e., P(*), to adjust for dot gain of the printing plates and press. The plate curve may be determined during an initialization of the color management system in a workflow screening analysis. Typically the plate curve is invertible such that an inverse plate curve, i.e., P⁻¹(*), may also be determined. The current estimated continuous-tone level in the bitmap image is denoted as “C” in FIG. 1. To enable color management, the current continuous-tone level is modified to obtain a desired continuous-tone level, denoted “D” in FIG. 1. Dot growth filter 20 then uses the current and desired continuous-tone levels to pick a threshold value that shrinks or grows halftone dots by an amount that produces the desired level in the modified bitmap.

The desired continuous-tone level D is determined by applying standard device profiling and color correction methods to the converted contone image. When performing device profiling and color correction it is more convenient to work with data in the original target color space, denoted as “O” in FIG. 1. The converted contone image is therefore passed through inverse plate curve module 17 to obtain estimates of the original image data, i.e., O=P⁻¹(C). In some cases, a plate curve P(*) may not be applied to the original image data. For example, if dot gain is not a concern for a particular printing press, a plate curve may be unnecessary. Therefore, inverse plate curve module 17 may not be included in processor 11 in some embodiments of the halftone print color management system.

Color mapping module 18 receives the estimated original image data O from inverse plate curve module 17. Color mapping module 18 performs color mapping on the received bitmap image bands to obtain the desired contone values D from the original contone values O. Color mapping module 18 may perform a one-dimensional color mapping or a multi-dimensional color mapping, such as an ICC device link. The halftone print color management system supports both one-dimensional and multi-dimensional color calibration techniques.

In the case of 1-D color calibration, a user or a program specifies a target dot gain curve T[*] and an intrinsic dot gain curve I[*] for each color channel. An overall correction curve, M[*]=I⁻¹[T[*]], can then be derived. The intrinsic dot gain curve should capture RIP, device, and media-related gains when producing halftone output. The gains may be obtained by processing a set of step wedges through a workflow RIP, which may include a plate curve. The bitmaps resulting from the processed step wedges are then printed on a proofing device. The halftone print color management system may support 1-D curves for each of cyan, magenta, yellow, and black channels, with an additional dot gain curve for all spot colors.

In the case of multi-dimensional color calibration, a user or a program specifies source and destination device profiles. There are no restrictions placed on the selection of the source profile other than compatibility with a CMYK device. Similar to the 1-D case, however, the destination device link should capture RIP, device, and media-related gains when producing halftone output. An appropriate destination profile may be produced by processing a profiling training target through a workflow RIP, which may include a plate curve. The bitmaps resulting from the processed profiling training target are then printed on a proofing device. Profiling software may be used to measure color output of the resulting proof and generate the destination profile.

A color matching module (CMM) uses the source and destination profiles to generate a constrained device link profile. A suitable CMM is the KPG Color Fidelity Module (CFM), available from Kodak Polychrome Graphics, LLC of Norwalk, Conn. The constraints placed on the link generation process avoid addition of a particular color in output device coordinates if that color was not present in input color coordinates. Since the halftone print color management system cannot add dots where they do not exist, these same constraints should be applied to the device link to ensure the color management system can produce output that is a geometric match with the original image. In some embodiments, a multi-dimensional profile adjuster may be used in conjunction with the device link generation process to provide user-selectable adjustments to the final color.

When multi-dimensional color management is selected, all four CMYK channels need to be available to allow the device link to be applied within contone path 26. In this case, the data paths in FIG. 1 are four channels wide instead of one, and the process executive must wait until all four input images are available before starting the color management process. When 1-D color management is activated, and for any spot channels, the data paths are one channel wide and processing can begin as soon as any channel's image is available. In the halftone print color management system described herein, spot colors, if present, are processed and color managed individually. All spot channel data may have the same 1-D color calibration and correction curves applied, or each spot channel may have individual calibration and correction curves applied.

Once values of the current and desired continuous-tone values C and D are available for the contone image bands, the values are sent to dot growth filter 20. A band of threshold values is specified based on a particular contone image band. Dot growth filter 20 applies the band of threshold values to a BDM-encoded halftone version of the particular image band. The threshold values manipulate pixels in the BDM image band to produce accurate tonal values. Dot growth filter 20 outputs the modified bitmap image bands for application to a proofing device.

One artifact that may arise in a proof from the color management system described above is “fat text.” When text and linework are subjected to the blur and reduce operation used to convert a halftone bitmap image to a contone bitmap image, black or white pixels along the perimeter are combined to produce mid-tone grays. Typically, the largest dot modifications are made in the mid-tone grey tonal range. Therefore, text may become artificially and undesirably bolder. To eliminate the fat text artifact, an edge mask may be generated from the contone converted image and used to disable bitmap modifications for all pixels in the vicinity of an edge. The edge mask is produced by applying an edge detection filter, such as a Laplacian, to the contone converted image and then thresholding the edge detector output so that only the strongest edges remain in the mask.

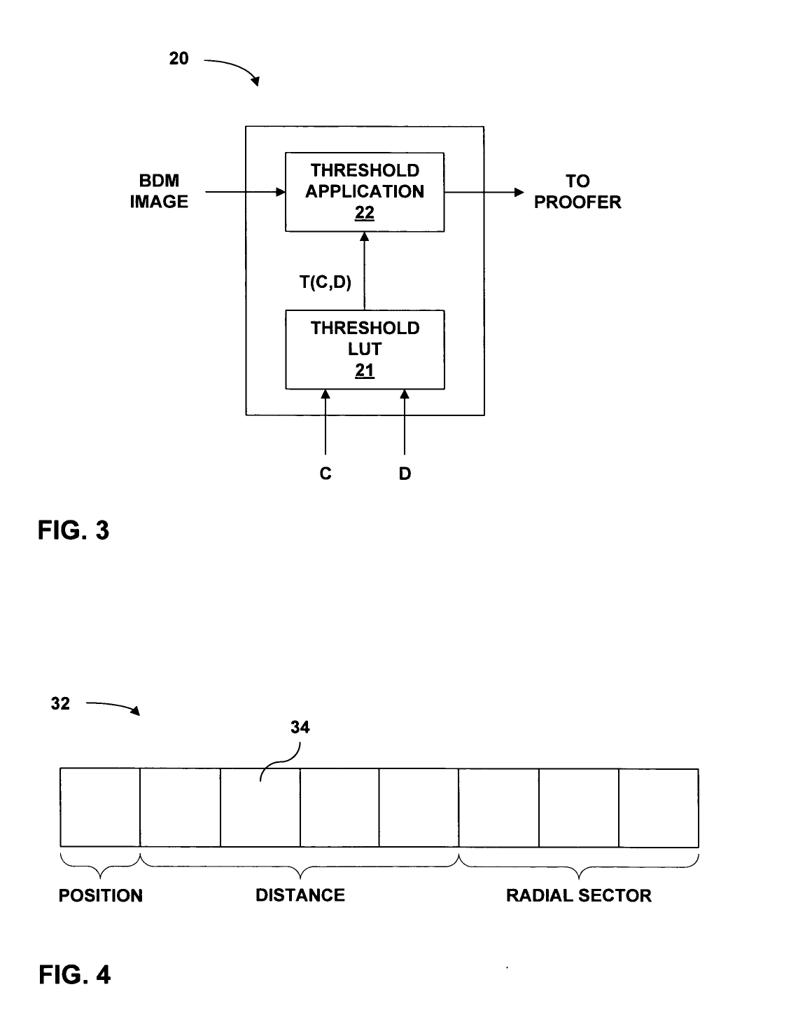

FIG. 3 is a block diagram illustrating dot growth filter 20 in greater detail. Dot growth filter 20 comprises a threshold look-up table (LUT) 21 and a threshold application module 22. As described above, BDM module 14 sends the BDM-encoded image bands to dot growth filter 20. Dot growth filter 20 receives bands of contone values and determines threshold values to be applied to the corresponding pixels of the BDM image bands to obtain a modified bitmap image.

Threshold LUT 21 accepts the contone values from contone path 26 to determine threshold values for the particular image band. The contone values include a band of current contone values C and a band of desired contone values D that correspond to each pixel of the particular image band. The current and desired values are used as indices for output threshold values stored in threshold LUT 21, i.e., T(C, D). Threshold LUT 21 stores the threshold values for application to the BDM-encoded image bands of original bitmap 10 to convert halftone dots from a size corresponding to the current contone level C to a size corresponding to the desired contone level D. Threshold LUT 21 may be initialized based on the screening analysis bitmaps used to determine the plate curve P(*). The construction process of threshold LUT 21 is described in greater detail below.

Threshold application module 22 accepts the BDM image bands from BDM module 14 as well as threshold values for the image bands from threshold LUT 21. Threshold application module 22 then applies the threshold values to the corresponding pixels of the BDM image bands. The threshold values manipulate halftone dots and/or inked areas within the BDM image bands to create a color accurate proof relative to original bitmap 10. The modified bitmap image output from threshold application module 22 may be stored and used directly to make a halftone proof.

FIG. 4 is a schematic diagram illustrating a bipolar distance mapped pixel word 32. Each pixel in a bipolar distance mapped (BDM) image is encoded with a pixel word 32, which includes eight bits 34. The first bit encodes a position of a given pixel relative to one of an interior and an exterior of a corresponding halftone dot. The next four bits encode a distance from the given pixel to a closest boundary pixel of the corresponding halftone dot. The last three bits of pixel word 32 encode a radial sector of the corresponding halftone dot in which the closest boundary pixel is located. In the illustrated embodiment, the radial sector comprises an octant of the corresponding halftone dot.

Due to the discrete nature of the representation of images within a computer, distances that result from distance mapping do not take on a continuous range of values and instead take one of a set of discrete distance values. It can be shown that if distances are limited to a maximum distance of 5.385 pixels, only 16 discrete distance values occur in the resulting distance mapped image. These 16 discrete distances may be represented in 4 bits of an 8 bit byte. The bipolar distance mapped image encoding therefore allocates 1 bit, the most significant bit, to indicate whether a given pixel is inside or outside a region, 4 bits for the distance from the border, and the 3 least-significant bits to encode which sector (one of eight wedges around the circle) the current pixel lies from the boundary, for a total of 8 bits to represent the encoded distance map. Also, by selecting 0 to represent “inside a region” and 1 for “outside”, and by inverting the distance encoding bits when the inside/outside bit equals 1, a single distance encoding is obtained that allows for either shrinking or growing regions as a threshold level is increased or decreased from a default value of 128.

Encoding each pixel of a bitmap image as described allows pixels within an octant of a halftone dot to be turned on or off before pixels within other octants to modify a perimeter of the halftone dot. In that way, each octant of a halftone dot may be controlled separately to increase color accuracy between a halftone proof and corresponding printing plates. The fractional boundary modification capability of BDM images allows fine color adjustment that is crucial for application to bitmap color management. Furthermore, the octant encoding allows the boundary pixels to be turned on or off in a pattern. For example, selectively modifying boundary pixels in a spiral pattern provides good control and a smooth color, and minimizes dot gain by increasing the halftone dot size in small increments. In other embodiments, boundary pixels may be modified using other patterns.

In some cases, a BDM image may be encoded with other encoding schemes that allow both dot growth and dot reduction based on a single varying threshold, and fractional dot perimeter modification based on a varying threshold. For example, a BDM image may be encoded with a pixel word which includes sixteen bits. The first bit encodes a position of a given pixel relative to one of an interior and an exterior of a corresponding halftone dot. The next eleven bits encode a distance from the given pixel to a closest boundary pixel of the corresponding halftone dot. The last four bits of the pixel word encode a radial sector of the corresponding halftone dot in which the closest boundary pixel is located. In the case of a 16-bit pixel word, the radial sector comprises one-sixteenth of the corresponding halftone dot. By proper specification of these bit fields, it is possible to obtain behavior similar to an 8-bit encoding case in terms of spiral dot perimeter modification with varying threshold, and both dot growth or reduction based on a single varying threshold.

FIG. 5 is a block diagram illustrating a workflow raster image processor (RIP) 37 generating an original bitmap 10. Workflow RIP 37 includes a plate curve module 38 and a halftoner 40. Original image data “O” 36 passes through workflow RIP 37 to generate original bitmap 10 from FIG. 1. A single pass through workflow RIP 37 allows original bitmap 10 to create both printing plates and, after application of the bitmap color management system illustrated in FIG. 1, a halftone proof.

Plate curve module 38 applies a plate curve, P(*), to original data 36 to compensate for dot gain experienced during the printing process. Typically, ink drops appear larger than expected once printed in a printing press. The increased dot size may reduce tonal and geometric accuracy of the halftone print relative to original data 36. Plate curve module 38 adjusts the size of pixels within original data 36 in order to achieve an accurate halftone print. A current contone value “C” is output from plate curve module 38 and input to halftoner 40. Halftoner 40 converts original data 36 into original halftone bitmap 10. Original bitmap 10 may be applied to the halftone print color management system illustrated in FIG. 1.

The plate curve P(*) and the inverse plate curve P⁻¹(*) are determined in a workflow screening analysis step as part of initializing the color management process. The analysis may be performed by processing a set of very fine step wedge targets through workflow RIP 37 to obtain a set of screening analysis bitmaps. Each color channel, including the spot channel, comprises a step wedge target. Each step wedge target includes a plurality of patches, preferably 256 patches to represent all the color levels for each channel. The screening analysis bitmaps are converted to contone images by a process substantially similar to that described above. Contone values corresponding to an interior of each step wedge color patch are averaged to directly obtain a sampled representation of the plate curve P(*). Generally, the plate curve is invertible, allowing P⁻¹(*) to be determined as well.

FIG. 6 is a schematic diagram illustrating an example halftone proofer 42. Halftone proofer 42 may comprise a high-level dedicated thermal proofing system, such as Kodak Polychrome Graphics (KPG) Matchprint Digital Halftone proofing system or Kodak Approval proofing system. Halftone proofer 42 includes a band writer 44 that creates a color adjusted bitmap 46. The modified bitmap image bands output from processor 11, of FIG. 1, are sent to band writer 44. Band writer 44 receives all the modified image bands of original bitmap 10 and recompiles the image bands into a single image file, i.e., color adjusted bitmap 46. Color adjusted bitmap 46 is a tonally and geometrically modified version of original bitmap 10. The color management system described above modifies perimeters of halftone dots in original bitmap 10 to generate color adjusted bitmap 46.

Color adjusted bitmap 46 is then used to create a halftone proof 48. Halftone proof 48 comprises color levels substantially similar to a halftone print of printing plates created from original bitmap 10. In this way, an accurate halftone proof is generated by a RIP-once workflow that reduces a difference between image data used to create printing plates and image data used to create a proof. In other embodiments, an alternate proofing method may be used to create a halftone proof from a modified bitmap image.

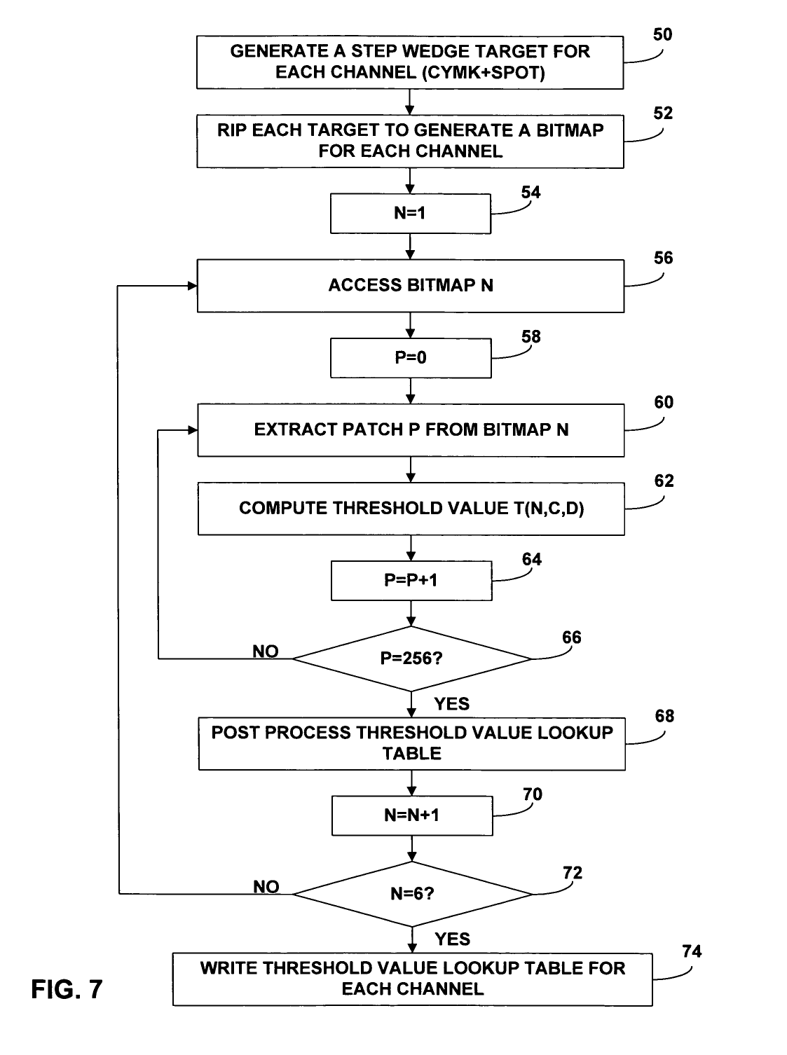

FIG. 7 is a flowchart illustrating a method of generating threshold value lookup tables, such as threshold LUT 21 of dot growth filter 20 shown in FIG. 3. The bitmap color management system requires a threshold lookup table, T(C, D), to be adjusted to properties of incoming image data. In other words, the threshold LUT is adjusted based on the properties of the screening system being used with the input images. A step wedge target with one step wedge for each color channel and one step wedge for spot colors is generated (50). Hereafter, it is assumed, with no loss of generality, that only one spot channel is present. Each step wedge target passes through a RIP, such as workflow RIP 37 from FIG. 5, to generate a bitmap for each channel (52). For best results, all contone gray levels (typically 256) should be represented in the step wedges.

The resulting five bitmaps (CMYK+Spot) are each analyzed in turn to construct a threshold value LUT for that channel. For the first channel, N=1 (54), the corresponding bitmap N is accessed (56). The bitmap N includes 256 image patches P that represent the 256 tonal levels in the color channel. The first patch, P=0 (58), is extracted from the first bitmap (60). A plurality of threshold values are then computed for channel N based on the current contone value C of patch P and the desired contone value D (62). The threshold value computation method is described in more detail below.

The threshold value computation method is performed for each patch P (64) until all of the patches in bitmap N have been processed, i.e., P=256 (66). The threshold value LUT created for channel N is post processed (68) in order to fill the threshold LUT with any current and desired continuous-tone data pairs (C, D) not produced by the patches. Threshold lookup tables are created for each channel N (70). Once all of the bitmaps have been processed, i.e., N=6 (72), the threshold value lookup tables are written for each of the color channels (74).

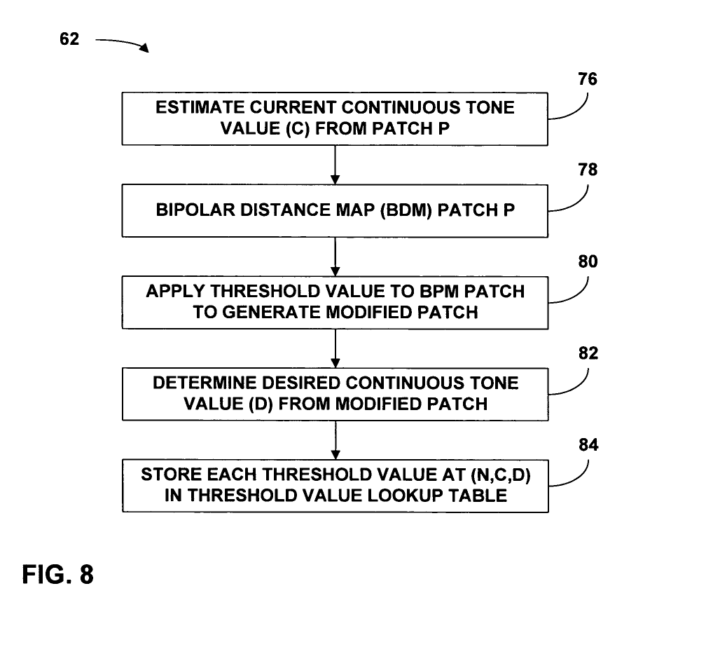

FIG. 8 is a flow chart illustrating a method of computing a threshold value T(N,C,D), step (62) from FIG. 7, in greater detail. For each patch P in the step wedge of channel N, a current contone value C represented by patch P is estimated (76). The estimate may be done by counting a number of foreground pixels in patch P. Patch P is then bipolar distance mapped (BDM) (78). A threshold level L is applied to the BDM patch to obtain a modified patch (80). The number of foreground pixels in the modified patch determines the corresponding desired contone value D (82) that is produced by threshold level L. The threshold value is stored at location (N, C, D) in the threshold lookup table of channel N (84). In some embodiments, a plurality of threshold levels is applied to the BDM patch to obtain a plurality of modified patches. Furthermore, each of the plurality of threshold values is stored at a location specified by the current continuous-tone value C and a desired continuous-tone value D determined from each of the plurality of modified patches.

The process described above can be rather time consuming. An accelerated method may be implemented by exploiting the counting method of determining the contone level represented by a bitmap image. The process of thresholding a gray-level image B at a level L, followed by counting the number of foreground pixels, is equivalent to determining the value of the cumulative histogram of B at gray level L, i.e., D=H_{B}(L). This process, described in more detail below, is an order of magnitude faster than the above described method.

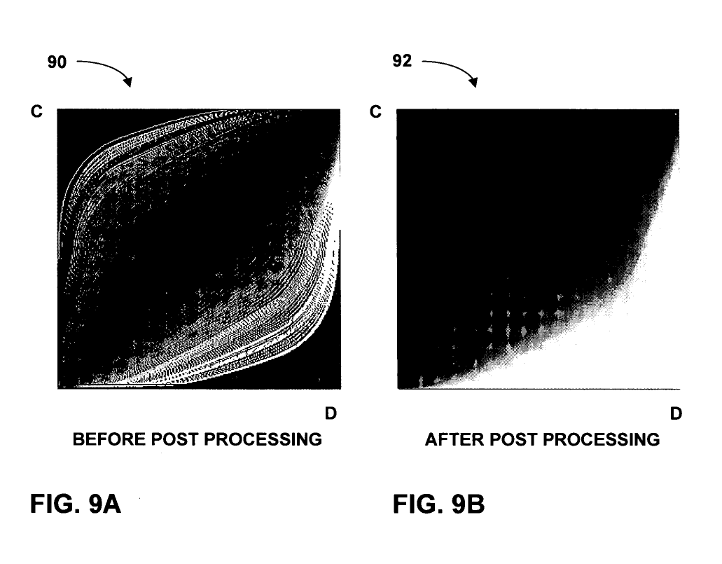

FIG. 9A is a plot illustrating a threshold LUT before post processing 90. FIG. 9B is a plot illustrating a threshold LUT after post processing 92. During the threshold LUT generation process, not all combinations of C and D are necessarily produced, even when all contone levels are represented in the step wedges. Furthermore, there may be multiple thresholds that produce the same (C, D) pair. In that case, the threshold value closest to the mid-range value, 128, is preferred. Due to missing and repeated (C, D) pairs, the T(C, D) tables that result may not be completely filled. For example, unfilled entries are illustrated as a mid-tone gray in before post processing plot 90.

Some form of post-processing may be required to fill in the missing data points. Splines may be fit to the available table entries, first along the rows, then along the columns. For each row or column, missing table entries are filled with spline-interpolated values. In other embodiments, alternate post processing techniques may be used. Filling the missing combinations into a threshold LUT results in after post processing plot 92. Post processing a threshold LUT completes the set of threshold values needed to create a halftone proof substantially similar to a halftone print.

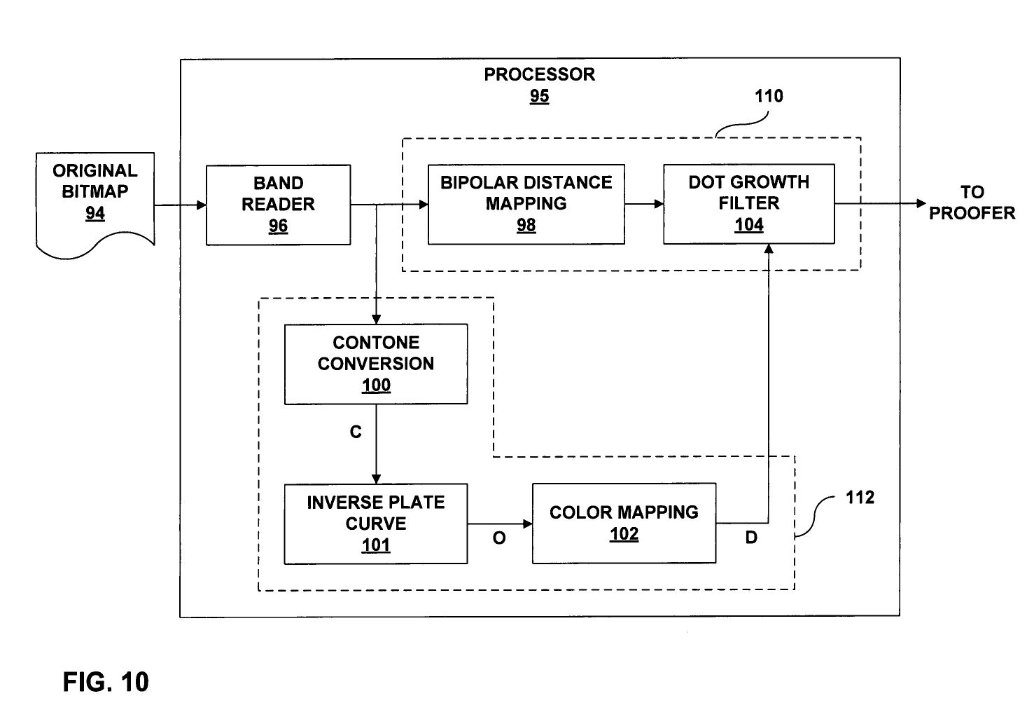

FIG. 10 is a block diagram illustrating another exemplary halftone print color management system. The halftone print color management system illustrated in FIG. 10 may be an alternative to the halftone print color management system illustrated in FIG. 1. The system described herein directly modifies a halftone bitmap image in order to minimize differences between data used to produce a proof and data used to produce corresponding printing plates. Substantially eliminating differences between the data leads to increased user confidence in the geometric and calorimetric accuracy of the resulting halftone proof.

As illustrated in FIG. 10, an original bitmap image 94 is provided as input to a processor 95 included in the color management system. Original bitmap image 94 may be used to create printing plates in a platesetter, for example. Processor 95 prepares bitmap image 94 to create a halftone proof substantially similar to an output from the printing plates. A workflow raster image processor (RIP), substantially similar to workflow RIP 37 illustrated in FIG. 5, may generate original bitmap image 94. In other embodiments, original bitmap image 94 may be generated by another means.

Processor 95, as illustrated in FIG. 10, includes a band reader 96, a bi-level path 110, and a continuous-tone (contone) path 112. Due to the file sizes that are typical of plate-ready bitmaps, band reader 96 allows original bitmap image 94 to be read and processed in image bands. Each of the image bands comprises a plurality of halftone dots and/or inked areas that may be manipulated to produce an accurate color in a halftone proof relative to original bitmap image 94.

Bi-level path 110 comprises elements necessary to perform halftone dot perimeter modifications. Bi-level path 110 includes a bipolar distance mapping (BDM) module 98 and a dot growth filter 104. Contone path 112 determines the degree of modification necessary for the halftone dots within a local region of original bitmap 94 to obtain the desired color output. Contone path 112 includes a contone conversion module 100, an inverse plate curve module 101, and a color mapping module 102. In the system of FIG. 10, unlike the system of FIG. 1, the current contone level C is not provided to dot growth filter 104. Instead, dot growth filter 104 receives the output of BDM module 98 and the desired contone level D from color mapping module 102.

BDM module 98 receives the image bands of original bitmap 94 from band reader 96. BDM module 98 bipolar distance maps the image bands by performing two passes of a standard EDM algorithm, as described above. A first pass produces a conventional EDM image. A second pass produces an EDM image with the foreground and background labels reversed. The two resulting EDM images are combined into a single BDM image that allows for shrinking or growing of foreground objects by varying a threshold value.

In addition to recording the distance from a closest boundary pixel for each pixel in a corresponding halftone dot, the image encoding scheme of BDM module 98 also records a position of each pixel relative to one of an interior or exterior of the halftone dot and a radial sector location in which a given pixel's nearest boundary pixel resides. In that way, each radial sector, e.g., an octant, of a halftone dot may be controlled separately to increase color accuracy between the halftone proof and the corresponding printing plates.

The boundary pixels of the BDM image are spatially selected for addition or removal based on the data encoded in each pixel by BDM module 98. The fractional boundary modification capability of BDM images allows finer control of color adjustment, which is crucial for application to bitmap color management. Application of a threshold to an EDM halftone bitmap is illustrated in FIG. 2A. Application of a threshold to a BDM halftone bitmap in accordance with an embodiment of the invention is illustrated in FIG. 2B.

BDM module 98 sends the BDM-encoded image bands to dot growth filter 104. Dot growth filter 104 receives bands of contone values and determines threshold values to be applied to the corresponding pixels of the BDM image bands to obtain a modified bitmap image. The bands of contone values are supplied by contone path 112, described in further detail below. The threshold values manipulate halftone dots and/or inked areas within the BDM image bands to create a color accurate proof relative to original bitmap 94. The modified bitmap image output from dot growth filter 104 may be stored and used directly to make a halftone proof.

Contone path 112 begins with a contone conversion module 100, which converts the image bands of original bitmap 94 from a high-resolution, bi-level image to a lower-resolution, continuous-tone image. Contone conversion module 100 performs the conversion by applying a two-pass Gaussian blur and reduce operation. The current estimated continuous-tone level in the bitmap image is denoted as “C” in FIG. 10. To enable color management, the current continuous-tone level is modified to obtain a desired continuous-tone level, denoted “D” in FIG. 10. Dot growth filter 104 then uses the desired continuous-tone levels D to pick a threshold value that shrinks or grows halftone dots by an amount that produces the desired level in the modified bitmap.

Each pixel of the contone-converted image represents an estimate of the continuous-tone value at a corresponding location within an original continuous-tone image. The original data may include an applied one-dimensional (1-D) plate curve, i.e., P(*), to adjust for dot gain of the printing plates and press. The plate curve may be determined during an initialization of the color management system in a workflow screening analysis. Typically the plate curve is invertible such that an inverse plate curve, i.e., P⁻¹(*), may also be determined.

The desired continuous-tone level D is determined by applying standard device profiling and color correction methods to the converted contone image. When performing device profiling and color correction it is more convenient to work with data in the original target color space, denoted as “O” in FIG. 10. The converted contone image is therefore passed through inverse plate curve module 101 to obtain estimates of the original image data, i.e., O=P⁻¹(C). In some cases, a plate curve P(*) may not be applied to the original image data. For example, if dot gain is not a concern for a particular printing press, a plate curve may be unnecessary. Therefore, inverse plate curve module 101 may not be included in processor 95 in some embodiments of the halftone print color management system.

Color mapping module 102 receives the estimated original image data O from inverse plate curve module 101. Color mapping module 102 performs color mapping on the received bitmap image bands to obtain the desired contone values D from the original contone values O. Color mapping module 102 may perform a one-dimensional color mapping or a multi-dimensional color mapping, such as an ICC device link. The halftone print color management system supports both one-dimensional and multi-dimensional color calibration techniques.

In the case of 1-D color calibration, a user or a program specifies a target dot gain curve T[*] and an intrinsic dot gain curve I[*] for each color channel. An overall correction curve, M[*]=I⁻¹[T[*]], can then be derived. The intrinsic dot gain curve should capture RIP, device, and media-related gains when producing halftone output. The gains may be obtained by processing a set of step wedges through a workflow RIP, which may include a plate curve. The bitmaps resulting from the processed step wedges are then printed on a proofing device. The halftone print color management system may support 1-D curves for each of cyan, magenta, yellow, and black channels, with an additional dot gain curve for all spot colors.

In the case of multi-dimensional color calibration, a user or a program specifies source and destination device profiles. There are no restrictions placed on the selection of the source profile other than compatibility with a CMYK device. Similar to the 1-D case, however, the destination device link must capture RIP, device, and media-related gains when producing halftone output. An appropriate destination profile may be produced by processing a profiling training target through a workflow RIP, which may include a plate curve. The bitmaps resulting from the processed profiling training target are then printed on a proofing device. Profiling software may be used to measure color output of the resulting proof and generate the destination profile.

When multi-dimensional color management is selected, all four CMYK channels should be available to allow the device link to be applied within contone path 112. In this case, the data paths in FIG. 10 are four channels wide instead of one, and the process executive must wait until all four input images are available before starting the color management process. When 1-D color management is activated, and for any spot channels, the data paths are one channel wide and processing can begin as soon as any channel's image is available. In the halftone print color management system described herein, spot colors, if present, are processed and color managed individually. All spot channel data may have the same 1-D color calibration and correction curves applied, or each spot channel may have individual calibration and correction curves applied.

Once values of the desired continuous-tone values D are available for the contone image bands, the values are sent to dot growth filter 104. A band of threshold values is specified based on a particular contone image band. Dot growth filter 104 applies the band of threshold values to a BDM-encoded halftone version of the particular image band. The threshold values manipulate pixels in the BDM image band to produce accurate tonal values. Dot growth filter 104 outputs the modified bitmap image bands for application to a proofing device.

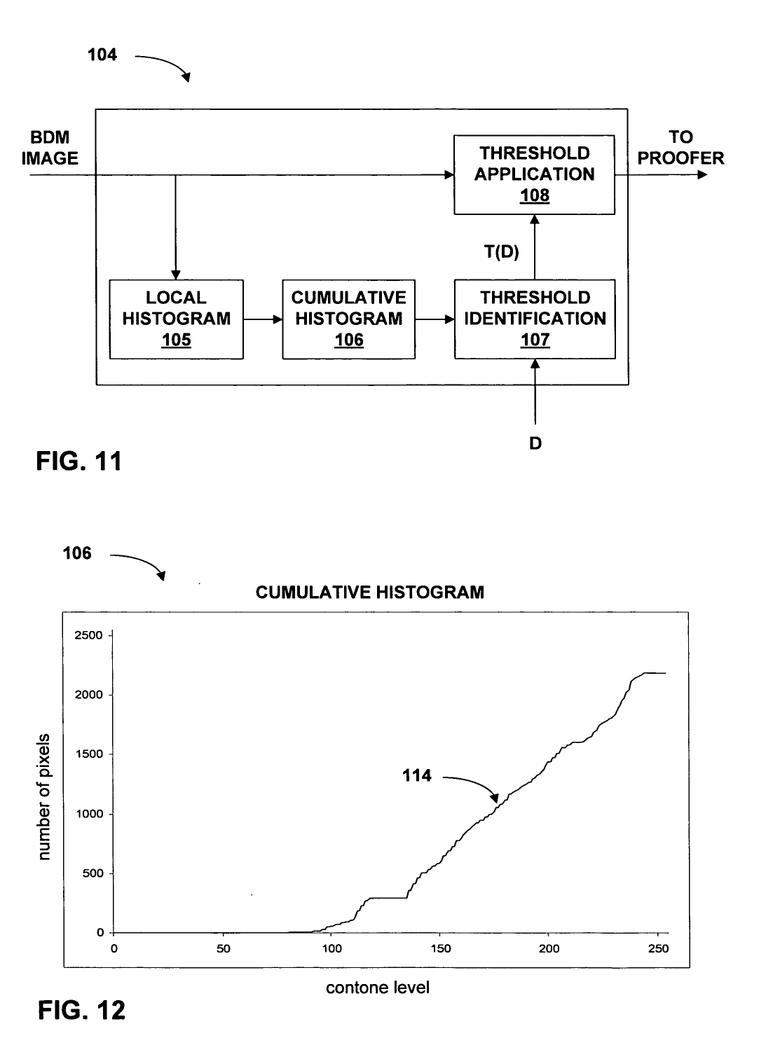

FIG. 11 is a block diagram illustrating dot growth filter 104 in greater detail. Dot growth filter 104 comprises a local histogram 105, a cumulative histogram 106, a threshold identification module 107, and a threshold application module 108. As described above, BDM module 98 sends the BDM-encoded image bands to dot growth filter 104. Dot growth filter 104 receives bands of contone values and determines threshold values to be applied to the corresponding pixels of the BDM image bands to obtain a modified bitmap image.

Dot growth filter 104 applies the BDM image bands to efficiently maintain local histogram 105, which identifies the number of pixels in a particular region of a BDM image band that have contone values 0 though 255. Dot growth filter 104 may maintain a local histogram for each of a plurality of color channels. The plurality of color channels may include a cyan channel, a yellow channel, a magenta channel, a black channel, and one or more spot color channels.

As an example, let the area of local histogram 105 be M×M pixels, and the stride, i.e., distance between centers of adjacent histogram centers, be S (typically 8) pixels. For a given line of pixels, local histogram 105 is first initialized using M² pixel values. Then, as the histogram center advances from one spot to the next, local histogram 105 may be updated by adding the contributions from S×M new pixel values on the right (assuming right to left processing) and subtracting the contributions from S×M old pixel values on the left. This update procedure represents an order of magnitude or better improvement in speed over recomputation of local histogram 105 at each spot.

For a given pixel, dot growth filter 104 uses local histogram 105 of BDM pixel values within a region centered on a corresponding pixel in a particular BDM image band to compute cumulative histogram 106. Computing cumulative histogram 106 comprises summing the number of pixels with a contone value less than or equal to each of contone values 0 through 255. Although local histogram 105 may be easily updated, cumulative histogram 106 is regenerated as the histogram center advances from one spot to the next. However, in some cases, cumulative histogram 106 may only need to be computed up to a desired contone value.

FIG. 12 is a plot illustrating cumulative histogram 106 of dot growth filter 104. Cumulative histogram 106 comprises an array H[T] that represents the number of BDM pixels 114 that have values less than or equal to an array index T, i.e., contone level. As shown in FIG. 12, the number of pixels 114 in the region increases with the contone level. For example, all of the pixels in a particular region will have contone values less than or equal to 255.

With further reference to FIG. 11, threshold identification module 107 accepts the desired contone level D from contone path 112. Threshold identification module 107 also accepts cumulative histogram 106 and finds the index T* for which cumulative histogram 106 equals D. Index T* is the required output threshold. In practice, the desired contone level D input to threshold identification 107 will typical have a continuous-tone level range of [0,255] for 8-bit images or [0,65535] for 16-bit images. The cumulative histogram 106 maximum will equal the number of pixels used to compute local histogram 105 (denoted as N). The values in D will therefore need to be rescaled to the range [0, N] before attempting to determine the output threshold.

Threshold application module 108 accepts the BDM image bands from BDM module 98 as well as threshold values T(D) for the image bands from threshold identification module 107. Threshold application module 108 then applies the threshold values to the corresponding pixels of the BDM image bands to obtain a modified bi-level image having the desired local equivalent contone value. The threshold values manipulate halftone dots and/or inked areas within the BDM image bands to create a color accurate proof relative to original bitmap 94. For example, for a given threshold value, threshold application 108 may turn on all pixels in a particular region with contone values less than or equal to the threshold value, as given in cumulative histogram 106. The modified bitmap image output from threshold application module 108 may be stored and used directly to make a halftone proof.

The halftone print color management systems illustrated in FIGS. 1 and 10 may undesirably affect edges such as linework and text. When edges are subjected to the blur and reduce operation, black and white pixels along their border are combined to produce mid-tone grays. This is the tonal range where the largest dot modifications are typically made so, for example, text becomes artificially and undesirably bolder or thinner. To eliminate this artifact, an edge mask may be generated from the contone converted image and used to disable bitmap modifications for all pixels in the vicinity of an edge. The edge mask may be produced by applying an edge detection filter such as a Laplacian to the contone converted image, then thresholding the edge detector output so that only the strongest edges, e.g., black on white, remain in the mask. Within the masked areas, the dot growth filter may be configured to apply a fixed threshold value and the value may be chosen to always grow, always shrink, or leave an area unaffected.

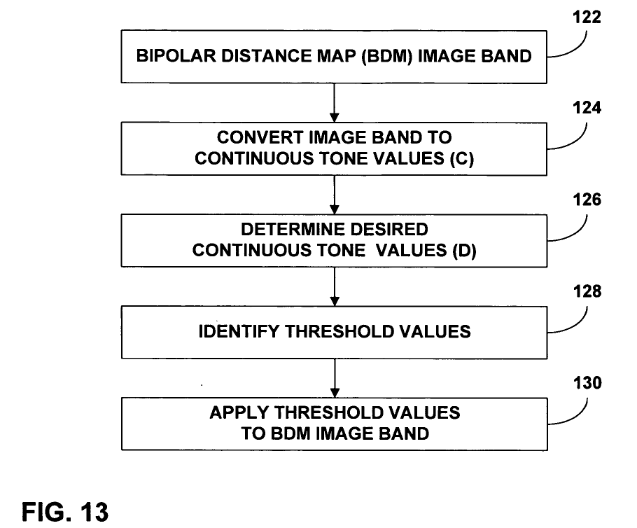

FIG. 13 is a flow chart illustrating a method of performing color management on bi-level halftone images. The method will be described herein in reference to FIG. 10. However, the method may also be applied to the bitmap color management process described in FIG. 1. Band Reader 96 allows original bitmap image 94 to be read and processed in image bands. BDM module 98 receives the image bands of original bitmap 94 from band reader 96. BDM module 98 bipolar distance maps the image bands (122).

Contone conversion module 100 converts the image bands of original bitmap 94 from a high-resolution, bi-level image to a lower-resolution, continuous-tone image (124). The current estimated continuous-tone level in the bitmap image is denoted as “C”. When performing device profiling and color correction it is more convenient to work with data in the original target color space, denoted as “O”. The contone-converted image may then be applied to inverse plate curve module 101 to obtain estimates of the original image data, i.e., O=P⁻¹(C).

The current continuous-tone level is modified to obtain a desired continuous-tone level, denoted “D” (126). The desired continuous-tone level D is determined by applying standard device profiling and color correction methods to the converted contone image. For example, color mapping module 102 receives the estimated original image data O from inverse plate curve module 101. Color mapping module 102 performs color mapping on the received bitmap image bands to obtain the desired contone values D from the original contone values O.

Once values of the desired continuous-tone values D are available for the contone image bands, the values are sent to dot growth filter 104. In the case of the bitmap color management process described in FIG. 1, both current contone values C and desired contone values D are sent to the dot growth filter. In the example of FIG. 10, only desired contone values D need to be sent to the dot growth filter. BDM module 98 sends the BDM-encoded image bands to dot growth filter 104. Dot growth filter 104 identifies threshold values to be applied to the corresponding pixels of the BDM image bands to obtain a modified bitmap image (128).

Dot growth filter 104 applies the band of threshold values to the BDM-encoded halftone version of the particular image band (130). The threshold values manipulate pixels in the BDM image band to produce accurate tonal values. Dot growth filter 104 outputs the modified bitmap image bands for application to a proofing device.

Various embodiments of the described invention are implemented by computer hardware, software, and firmware. Exemplary computer hardware may include programmable processors such as microprocessors, Application-Specific Integrated Circuits (ASIC), Field-Programmable Gate Arrays (FPGA), or other equivalent integrated or discrete logic circuitry. A processor may execute instructions stored in a computer-readable medium to perform various functions described herein. Exemplary computer-readable media may include or utilize magnetic or optical tape or disks, solid state volatile or non-volatile memory, including random access memory (RAM), read only memory (ROM), electronically programmable memory (EPROM or EEPROM), or flash memory, as well as other data storage media.

Various embodiments of the invention have been described. For example, a halftone print color management technique has been described. The color management technique enables a RIP-once process that provides a bitmap image for both a halftone proof and corresponding printing plates. The bitmap image is bipolar distance mapped and locally thresholded to produce a halftone proof with a color level substantially similar to output of the corresponding printing plates. The bitmap color management processes described herein perform localized modifications of halftone dot perimeters. The dot growth or reduction is based on at least a desired contone value as determined from a user-specified color mapping such as 1-D curves or an ICC device link profile, using an estimated current contone value as the input to the curves or device link. These and other embodiments are within the scope of the following claims.

1. A method for adjusting color in a bitmap image comprising locally modifying a perimeter of a halftone dot within the bitmap image by applying a local threshold value to a distance mapped bitmap image.

2. The method of claim 1, wherein locally modifying the perimeter of the halftone dot comprises one of turning on and off spatially selected border pixels of the halftone dot based on the local threshold value.

3. The method of claim 2, wherein the border pixels are spatially selected in a spiral pattern around the halftone dot.

4. The method of claim 1, further comprising bipolar distance mapping the bitmap image and applying the local threshold value to the bipolar distance mapped bitmap image.

5. The method of claim 4, wherein bipolar distance mapping the bitmap image comprises encoding each pixel of the bitmap image as exterior or interior to a corresponding halftone dot, with a distance from a closest border pixel of the halftone dot, and with a radial sector location of the closest border pixel, wherein encoding the pixels enables control of pixels within each radial sector of the halftone dot.

6. The method of claim 5, wherein applying the local threshold value to the bipolar distance mapped bitmap image comprises applying the local threshold value to the encoded pixels.

7. The method of claim 6, wherein applying the local threshold value to the encoded pixels comprises one of turning on and off spatially selected border pixels of the halftone dot, the border pixels spatially selected based on the encoded data.

8. The method of claim 5, wherein each encoded pixel comprises an 8-bit word with 1-bit encoding the position of the pixel as exterior or interior to the halftone dot, 4-bits encoding the distance from the closest border pixel of the halftone dot, and 3-bits encoding the radial sector location of the closest border pixel.

9. The method of claim 1, further comprising selecting the local threshold value based on a desired local continuous-tone value.

10. The method of claim 9, further comprising determining the desired local continuous-tone value from a color mapping of a current local continuous-tone value estimated from the bitmap image.

11. The method of claim 9, further comprising maintaining a local histogram of a number of pixels in a region of the distance mapped bitmap image with given continuous-tone values.

12. The method of claim 11, further comprising maintaining a local histogram for each of a plurality of color channels.

13. The method of claim 12, wherein the plurality of color channels includes a cyan, a yellow, a magenta, a black, and a spot color channel.

14. The method of claim 12, wherein maintaining the local histogram comprises removing old data from the local histogram and adding new data to the local histogram as a center of the local histogram moves across the distance mapped bitmap image.

15. The method of claim 12, further comprising generating a cumulative histogram for a given pixel based on the local histogram.

16. The method of claim 15, wherein generating the cumulative histogram comprises summing a number of pixels with continuous-tone values less than or equal to given continuous tone values.

17. The method of claim 16, wherein selecting the local threshold value based on the desired local continuous-tone value comprises determining a continuous-tone value of the cumulative histogram that approximately equals the desired local continuous-tone value.

18. The method of claim 1, further comprising selecting the local threshold value based on a current local continuous-tone value and a desired local continuous-tone value.

19. The method of claim 18, further comprising estimating the current local continuous-tone value from the bitmap image and determining the desired local continuous-tone value from a color mapping of the current local continuous-tone value.

20. The method of claim 19, wherein estimating the current local continuous-tone value comprises applying a two-pass Gaussian blur and reduce operation to the bitmap image, wherein a first pass operates on bytes of the bitmap image and a second pass operates on blurred and reduced images output from the first pass.

21. The method of claim 18, further comprising creating a threshold value table by storing each local threshold value at a location specified by the current and desired continuous-tone values.

22. The method of claim 21, further comprising creating a threshold value table for each of a plurality of color channels.

23. The method of claim 21, wherein selecting the local threshold value based on the current local continuous-tone value and the desired local continuous-tone value comprises applying the current and desired local continuous-tone values to the threshold value table.

24. The method of claim 21, wherein creating the threshold value table comprises:
generating a bitmap from a step wedge target that includes a plurality of patches;
extracting one of the plurality of patches from the bitmap;
estimating a current continuous-tone value from the patch;
bipolar distance mapping the patch;
applying a threshold value to the bipolar distance mapped patch to generate a modified patch;
determining a desired continuous-tone value from the modified patch; and
storing the threshold value in the threshold table at a location specified by the current continuous-tone value and the desired continuous-tone value.

25. The method of claim 24, further comprising applying a plurality of threshold values to the bipolar distance mapped patch to generate a plurality of modified patches and storing each of the plurality of threshold values in the threshold table at a location specified by the current continuous-tone value and a desired continuous-tone value determined from each of the plurality of modified patches.

26. A computer-readable medium for adjusting color in a bitmap image comprising instructions to cause a programmable processor to locally modify a perimeter of a halftone dot within the bitmap image by applying a local threshold value to a distance mapped bitmap image.

27. The computer-readable medium of claim 26 wherein the instructions to cause the programmable processor to locally modify the perimeter of the halftone dot cause the programmable processor to one of turn on and off spatially selected border pixels of the halftone dot based on the local threshold value.

28. The computer-readable medium of claim 26, further comprising instructions to cause the programmable processor to bipolar distance map the bitmap image and apply the local threshold value to the bipolar distance mapped bitmap image.

29. The computer-readable medium of claim 28, wherein the instructions cause the programmable processor to bipolar distance map the bitmap image cause the programmable processor to encode each pixel of the bitmap image with a position one of exterior and interior to a corresponding halftone dot, a distance from a closest border pixel of the halftone dot, and a radial sector location of the closest border pixel, wherein encoding the pixels enables control of each radial sector of the halftone dot.

30. The computer-readable medium of claim 29, wherein each encoded pixel comprises an 8-bit word with 1-bit encoding the position of the pixel one of exterior and interior to the halftone dot, 4-bits encoding the distance from the closest border pixel of the halftone dot, and 3-bits encoding the radial sector location of the closest border pixel.

31. The computer-readable medium of claim 26, further comprising instructions to cause the programmable processor to select the local threshold value based on a desired local continuous-tone value.

32. The computer-readable medium of claim 26, further comprising instructions to cause the programmable processor to select the local threshold value based on a current local continuous-tone value and a desired local continuous-tone value.

33. A system comprising a processor that color adjusts an original bitmap image by locally modifying a perimeter of a halftone dot within the bitmap image by applying a local threshold value to a distance mapped bitmap image.

34. The system of claim 33, further comprising a raster image processor that generates the original bitmap image.

35. The system of claim 33, further comprising a platesetter that produces printing plates based on the original bitmap image.

36. The system of claim 33, further comprising a proofer that produces a halftone proof based on the color adjusted bitmap image.

37. The system of claim 33, wherein the processor converts the original bitmap image to a continuous tone representation, color maps the continuous tone representation, bipolar distance maps the original bitmap image to produce the distance mapped bitmap image, and applies a dot growth filter to generate the local threshold value based on the color mapped continuous tone representation.
